(19) United States
(12) Patent Application Publication
(10) Pub. No.: US 2011/0026060 A1
(43) Pub. Date: Feb. 3, 2011

(54) Hose device, image reading apparatus, and method of controlling image reading apparatus using host device

(75) Inventors: Kyung-hoon Kang, Suwon-si (KR); Hak-ju Lee, Suwon-si (KR); Jung-mo Hong, Suwon-si (KR); Hyun-jung Park, Seoul (KR); Dong-hoan Koo, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/656,774

(22) Filed: Feb. 16, 2010

(30) Foreign Application Priority Data
Jul. 31, 2009 (KR) 2009-0070741

(51) Int. Cl. G06F 3/12; H04N 1/32; G06F 15/00

(52) U.S. Cl. 358/1.13; 358/442; 358/1.15

(57) ABSTRACT

A host device, an image reading apparatus, and a method of controlling the image reading apparatus using the host device are provided. A method of controlling an image reading apparatus using a host device includes receiving input of at least one scanning function for an image reading apparatus to be used, searching for at least one image reading apparatus connected to the host device, extracting at least one image reading apparatus supporting the at least one scanning function based on the search result, displaying a list of the extracted at least one image reading apparatus, and displaying a driver user interface (UI) corresponding to a selected image reading apparatus when an image reading apparatus to be used is selected from the list. Therefore, the user may select a desired image reading apparatus with greater ease.

### CROSS-REFERENCE TO RELATED APPLICATIONS

This application claims all benefits accruing under 35 U.S.C. §119 from Korean Application No. 2009-70741, filed Jul. 31, 2009, in the Korean Intellectual Property Office, the disclosure of which is incorporated herein by reference.

### BACKGROUND

1. Field

Aspects of the present embodiments relate to a host device, an image reading apparatus, and a method of controlling the image reading apparatus using the host device, and more particularly, to a host device capable of providing a list of image reading apparatuses having a scanning function desired by the user, an image reading apparatus, and a method of controlling the image reading apparatus using the host device.

2. Description of the Related Art

In general, a single computer is connected to a single scanner. However, according to the development of networks, a plurality of computers can be connected to a plurality of scanners via diverse types of networks. Accordingly, a user may select and use a desired one of the plurality of scanners connected through the networks.

To use scanners, a driver program for each scanner should be installed in computers because different driver programs are used according to the manufacturer or model.

Accordingly, to use a particular scanner, the user experiences inconvenience of installing a driver program for the scanner in his or her computer.

To remove this inconvenience, a general-purpose scanner driver program capable of controlling a plurality of scanners using a single driver program is introduced. If the general-purpose scanner driver program is used, there is no need to install a driver program for each scanner.

If a related art general-purpose scanner driver program is executed, the related art general-purpose scanner driver program searches for all the scanners which are connected to a computer via a network or locally, and a list of scanners are displayed so that the user can select a scanner to be used.

When the list of scanners are displayed using the related art general-purpose scanner driver program, all the scanners which are connected to the computer or all the multifunction peripherals having a scanning function may be displayed, so it may be difficult to select one from the list.

In addition, since the list of scanners displays only simple information, there may be a problem in that the user may select a scanner when the user does not know the function of the scanners well. In this case, if the selected scanner cannot support a desired function, the user has to repeat the process of selecting another scanner and checking whether or not the newly selected scanner can support the desired function.

Therefore, there is a need for methods for the user to select a desired scanner more rapidly and conveniently.

### SUMMARY

Aspects of the present embodiments provide a host device capable of providing a list of image reading apparatuses having a desired scanning function, thereby facilitating selection of an appropriate image reading apparatus from among a plurality of image reading apparatuses, an image reading apparatus, and a method of controlling the image reading apparatus using the host device.

Additional aspects and/or advantages will be set forth in part in the description which follows and, in part, will be obvious from the description, or may be learned by practice of the invention.

The foregoing and/or other aspects are achieved by providing a method of controlling an image reading apparatus using a host device connected to at least one image reading apparatus, the method including: receiving input of at least one scanning function for an image reading apparatus to be used; searching for at least one image reading apparatus connected to the host device; extracting at least one image reading apparatus supporting the at least one scanning function based on the search result; displaying a list of the extracted at least one image reading apparatus; and displaying a driver user interface (UI) corresponding to the selected image reading apparatus when an image reading apparatus to be used is selected from the list.

The method may further include performing a scanning operation of the selected image reading apparatus based on an input received at the driver UI.

The method may further include executing the general-purpose image reading apparatus driver unit, wherein the general-purpose image reading apparatus driver unit may provide a UI to receive the at least one scanning function as input.

The at least one scanning function may be input using a preset setting indicating a pre-stored scanning function.

The receiving the input may include: displaying at least one pre-stored preset setting; and receiving the input of the at least one scanning function by selecting at least one of the displayed preset settings.

The method may further include registering the selected image reading apparatus in a use list.

The foregoing and/or other aspects are achieved by providing a method of controlling an image reading apparatus using a host device having a general-purpose image reading apparatus driver unit capable of controlling a plurality of image reading apparatuses, the method including: executing the general-purpose image reading apparatus driver unit; receiving input of at least one scanning function for one of the image reading apparatuses to be used; searching for at least one image reading apparatus which is connected to the host device based on the input scanning function; receiving a response from at least one image reading apparatus supporting the input scanning function; displaying a list of the at least one image reading apparatus which transmits the response; and displaying a driver user interface (UI) corresponding to a selected image reading apparatus when an image reading apparatus to be used is selected from the list.

The method may further include performing a scanning operation of the selected image reading apparatus based on the driver UI.

The response from the at least one image reading apparatus may contain a scanning function supported by the at least one image reading apparatus.

The foregoing and/or other aspects are achieved by providing a host device connected to at least one image reading apparatus, the host device including: an input unit to receive input of at least one scanning function for an image reading apparatus to be used; a general-purpose image reading apparatus driver unit to search for the at least one image reading apparatus connected to the host device, and to extract at least one image reading apparatus supporting the at least one scanning function based on the search result; and a display unit to display a list of the extracted at least one image reading apparatus, wherein the general-purpose image reading apparatus driver unit displays a driver user interface (UI) corresponding to a selected image reading apparatus on the display unit when an image reading apparatus to be used is selected from the list.

The foregoing and/or other aspects are achieved by providing a host device connected to at least one image reading apparatus, the host device including: an input unit to receive input of at least one scanning function for an image reading apparatus to be used; a general-purpose image reading apparatus driver unit to search for at least one image reading apparatus connected to the host device based on the input scanning function; an interface unit to receive a response from at least one image reading apparatus supporting the input scanning function; and a display unit to display a list of the at least one image reading apparatus that transmits the response, wherein the general-purpose image reading apparatus driver unit displays a driver user interface (UI) corresponding to a selected image reading apparatus on the display unit when an image reading apparatus to be used is selected from the list.

The foregoing and/or other aspects are achieved by providing an image reading apparatus connected to a host device and operating according to control of the host device, the image reading apparatus including: a storage unit storing supportable scanning information; an interface unit to receive a search signal from the host device; and a control unit compares information regarding the scanning function with the scanning information stored in the storage unit when the search signal contains information regarding a scanning function, and transmits a response signal to the host device through the interface unit when at least one information regarding the scanning function is identical with the scanning information stored in the storage unit as a result of the comparison.

The control unit may not transmit the response signal to the host device when there is no identical information as a result of the comparison.

The host device may include a general-purpose image reading apparatus driver unit capable of controlling the at least one image reading apparatus.

The foregoing and/or other aspects are achieved by providing a method of controlling an image reading apparatus using a host device connected to at least one image reading apparatus, the method including: receiving input of at least one desired scanning function for at least one of the image reading apparatuses to be controlled; transmitting a search signal to search for at least one image reading apparatus from the at least one image reading apparatus connected to the host device; receiving a response signal from at least one image reading apparatus connected to the host device in response to the search signal; and extracting at least one image reading apparatus capable of supporting the desired scanning function based on a result of the received response signals and displaying a list of the extracted at least one image reading apparatus.

The search signal may be a signal requesting a response signal from all of the image reading apparatuses connected to the host device, and the host device may determine image reading apparatuses capable of supporting the desired scanning function based on the response signals received from all of the image reading apparatuses connected to the host device.

The search signal may be a signal requesting a response signal only from image reading apparatuses capable of supporting the desired scanning function, and the host device may determine image reading apparatuses capable of supporting the desired scanning function based on the response signals received from only the image reading apparatuses connected to the host device.

One of the image reading apparatuses may be selected from the list and controlled to perform the desired scanning function.

A determination may be made, prior to searching for the image reading apparatuses, as to whether an image reading apparatus to be used is to be selected from a pre-registered use list, and an image reading apparatus from the pre-registered use list may be selected from the use list and controlled to perform the desired scanning function when it is determined that the image reading apparatus to be used is to be selected from the pre-registered use list.

In addition to the example embodiments and aspects as described above, further aspects and embodiments will be apparent by reference to the drawings and by study of the following descriptions.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a scan system according to an example embodiment;

FIG. 2 is a schematic block diagram of a host device according to an example embodiment;

FIG. 3 illustrates an example of a packet of an image reading apparatus search signal according to an example embodiment;

FIG. 4 illustrates an example of a user interface to display a list of image reading apparatuses according to an example embodiment;

FIGS. 5A to 5C illustrate examples of a user interface to receive as input a scanning function according to an example embodiment;

FIG. 6 is a flow chart illustrating a method of controlling an image reading apparatus using a host apparatus according to an example embodiment;

FIG. 7 is a flow chart illustrating a method of controlling an image reading apparatus using a host apparatus according to another embodiment; and

FIG. 8 is a flow chart illustrating a method of controlling an image reading apparatus using a host apparatus according to yet another embodiment.

### DETAILED DESCRIPTION

Reference will now be made in detail to the present embodiments, examples of which are illustrated in the accompanying drawings, wherein like reference numerals refer to the like elements throughout. The embodiments are described below in order to explain the present invention by referring to the figures.

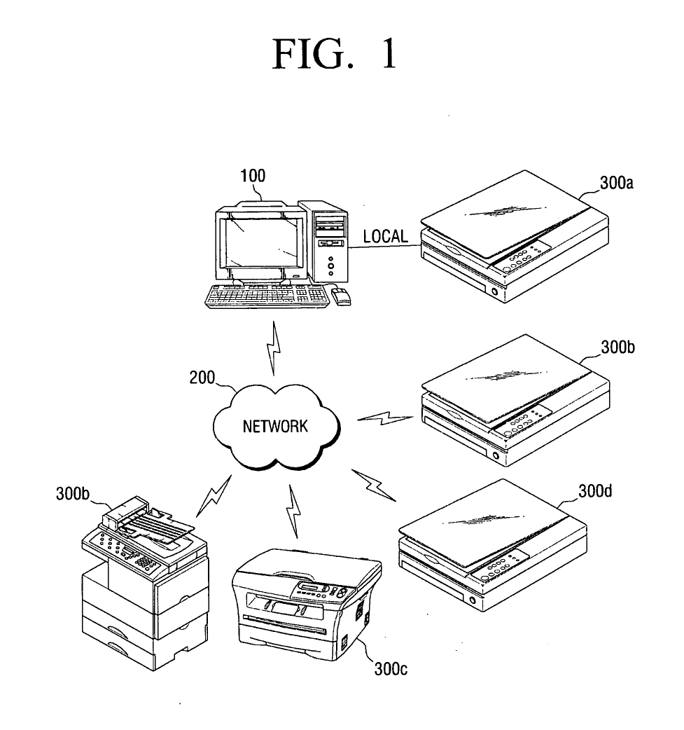

FIG. 1 illustrates a configuration of a scan system according to an example embodiment.

Referring to FIG. 1, the scan system according to an example embodiment may include a host device 100 and a plurality of image reading apparatuses 300a to 300e. The host device 100 may be connected to the plurality of image reading apparatuses 300a to 300e locally, such as through universal serial bus (USB), or via a network 200.

The host device 100 may install a general image reading apparatus driver unit (not shown) and a general-purpose image reading apparatus driver unit to control the plurality of image reading apparatuses 300a to 300e.

The general image reading apparatus driver unit indicates a driver program provided for each of the plurality of image reading apparatuses 300a to 300e, and the general-purpose image reading apparatus driver unit indicates a driver program capable of controlling all of the plurality of image reading apparatuses 300a to 300e using a single driver program.

In this embodiment, the host device 100 should necessarily install the general-purpose image reading apparatus driver unit, but may selectively install the general image reading apparatus driver unit. The host device 100 may be a personal computer.

The plurality of image reading apparatuses 300a to 300e are devices having a scanning function, and are connected to the host device 100 through a local connection or via a network 200. The plurality of image reading apparatuses 300a to 300e may be stand-alone devices having a scanning function or be multifunction peripherals having a printing function, a fax function, or a copy function, as well as a scanning function.

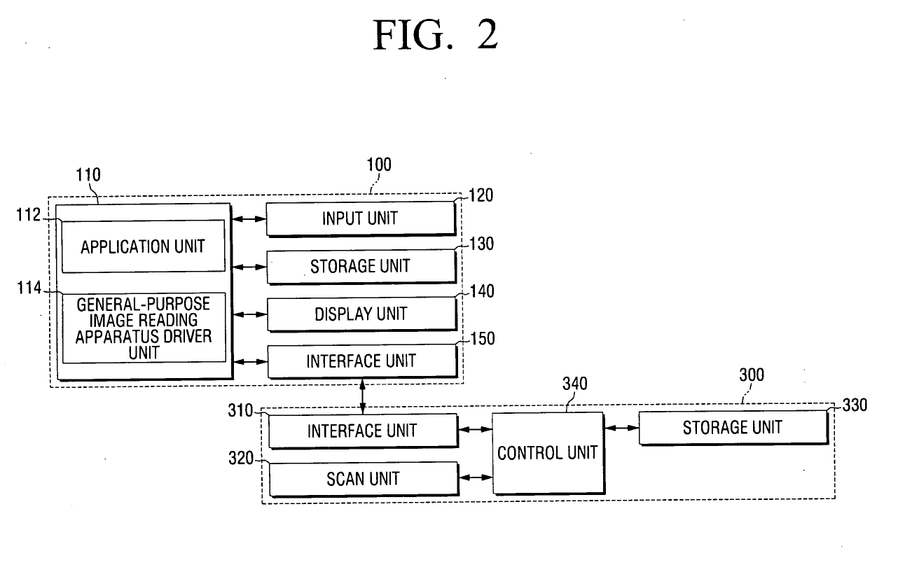

The configuration of the host device 100 and the plurality of image reading apparatuses 300a to 300e is discussed with reference to FIG. 2.

In this embodiment, the host device 100 is connected to the image reading apparatus 300a through a local connection, and is connected to the four image reading apparatuses 300b to 300e via a network 200. However, this is merely for convenience of description. The number of image reading apparatuses 300a to 300e which are connected to the host device 100, the number of image reading apparatus 300a which is connected to the host device 100 in a local way, and the number of image reading apparatuses 300b to 300e which are connected to the host device 100 via the network 200 are not limited thereto.

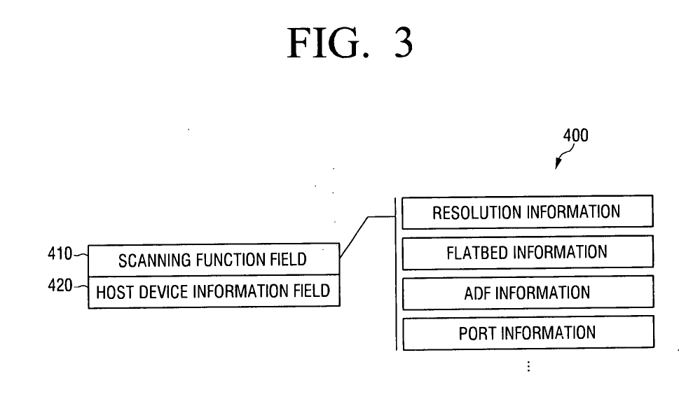

FIG. 2 is a schematic block diagram of a host device according to an example embodiment, and FIG. 3 illustrates an example of a packet of an image reading apparatus search signal according to an example embodiment.

Referring to FIG. 2, the host apparatus 100 according to an example embodiment may include a main controller 110, an input unit 120, a storage unit 130, a display unit 140, and an interface unit 150.

The main controller 110 may include an application unit 112 and a general-purpose image reading apparatus driver unit 114. Although not shown in FIG. 2, the application unit 112 and the general-purpose image reading apparatus driver unit 114 in the main controller 110 are operated by an operating system (OS).

The application unit 112 is a program which the user executes to use one of the plurality of image reading apparatuses 300a to 300e. The application unit 112 may be an image edit program, or a scanner program provided by the OS.

If the user selects the general-purpose image reading apparatus driver unit 114 using a menu provided by the application unit 112, the application unit 112 executes the general-purpose image reading apparatus driver unit 114.

The general-purpose image reading apparatus driver unit 114 is executed by the user selecting the general-purpose image reading apparatus driver unit 114 using the menu provided by the application unit 112.

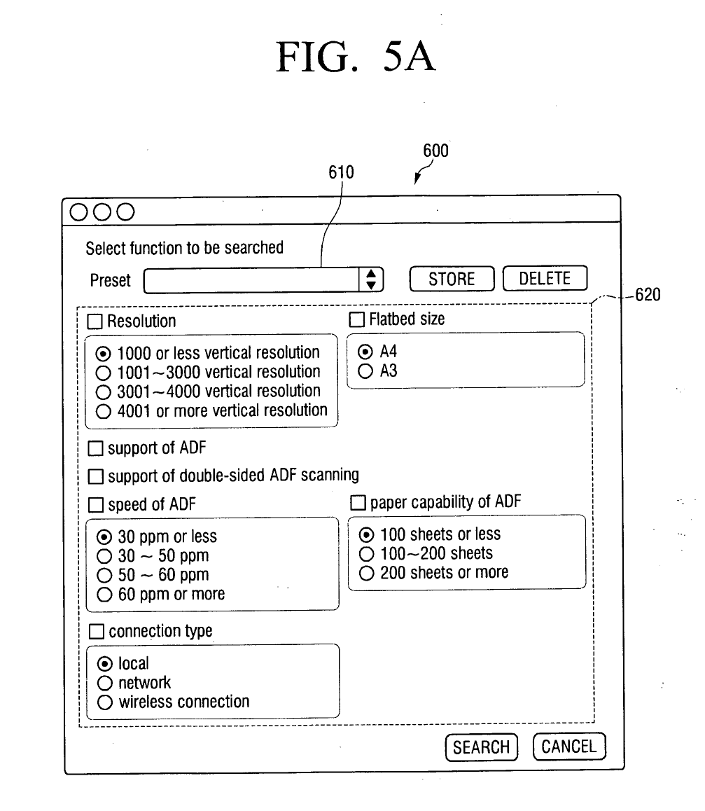

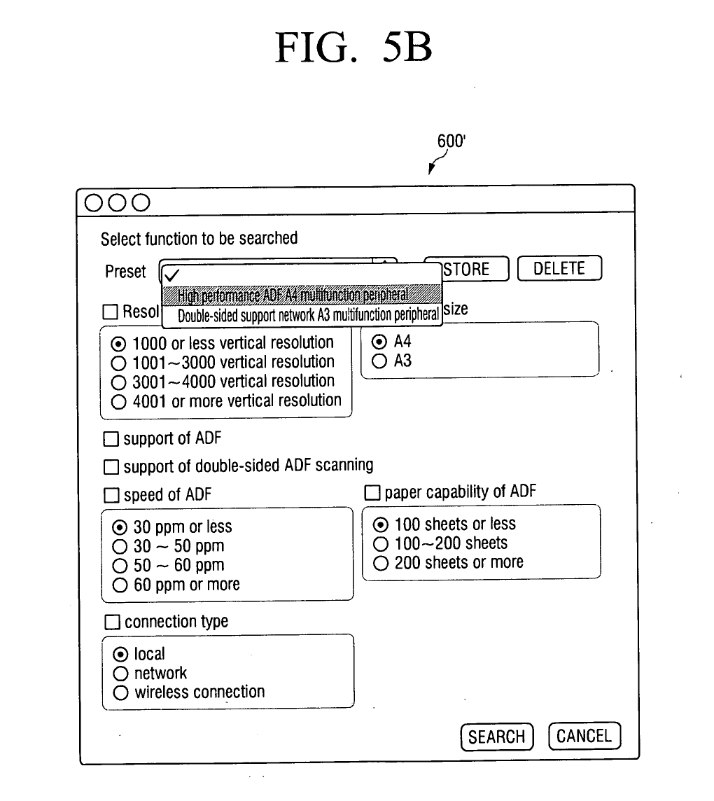

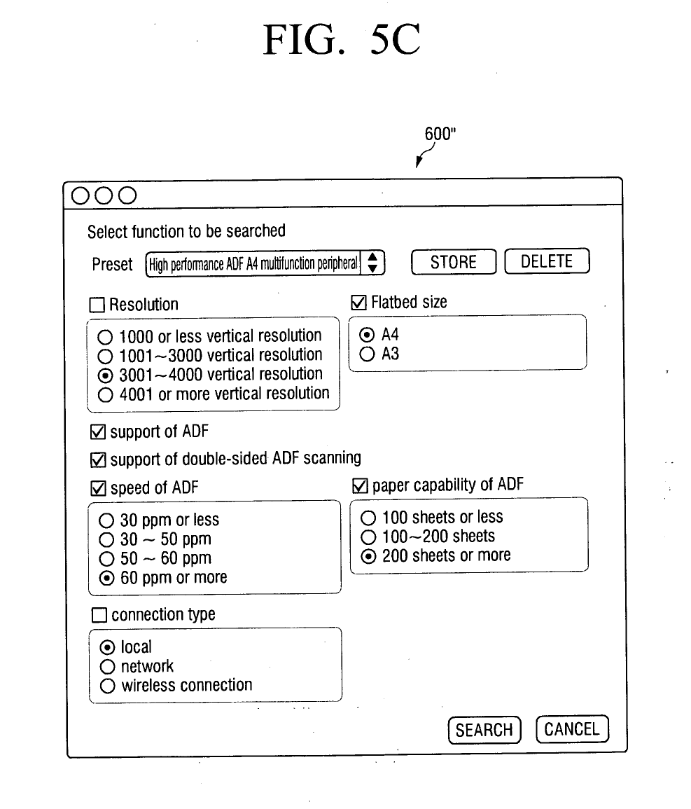

The general-purpose image reading apparatus driver unit 114 provides a user interface (UI) to receive an input of a scanning function, so the user can input a desired scanning function. That is, the general-purpose image reading apparatus driver unit 114 receives input of at least one setting value for a scanning function through the UI to input the scanning function, and generates a preset setting including the input setting value. The preset setting indicates a preset scanning function, which may be stored in an Extensible Markup Language (XML). The UI to input a scanning function is described in greater detail with reference to FIGS. 5A to 5C.

A scanning function may include a resolution range, a flatbed size, a support of Automatic Document Feeder (ADF), a support of double-sided ADF, a speed of ADF, a paper capability of ADF, types of supportable ports, etc.

The general-purpose image reading apparatus driver unit 114 generates a search signal to search for the plurality of image reading apparatuses 300a to 300e which are connected to the host device 100. The search signal may be a signal to request a response from all the image reading apparatuses 300a to 300e which are connected to the host device 100, or may be a signal to request a response only from image reading apparatuses supporting the scanning function input by the user from among the plurality of image reading apparatuses 300a to 300e which are connected to the host device 100.

If the search signal is a signal requesting a response from all the image reading apparatuses 300a to 300e which are connected to the host device 100, the general-purpose image reading apparatus driver unit 114 extracts at least one image reading apparatus corresponding to the scanning function based on the search result.

If the general-purpose image reading apparatus driver unit 114 generates a search signal requesting a response only from image reading apparatuses supporting the scanning function input by the user, a packet 400 of a search signal, illustrated in FIG. 3, is generated. Since a search signal requesting a response from all the image reading apparatuses 300a to 300e which are connected to the host device 100 is well known, description thereof is omitted here.

Referring to FIG. 3, the packet 400 of the search signal may include a scanning function field 410 and a host device information field 420. The scanning function field 410 may include a scanning function desired by the user, that is, a scanning function input through the UI to receive an input of a scanning function. The host device information field 420 may include device information regarding the host device 100, such as Internet Protocol (IP), port information, etc., so that an image reading apparatus which received the packet 400 of the search signal can transmit a response to the host device 100.

If the general-purpose image reading apparatus driver unit 114 generates and transmits the packet 400 of the search signal as illustrated in FIG. 3, the plurality of image reading apparatuses 300a to 300e receive the packet 400, compare information contained in the scanning function field 410 with their own scanning function, and transmit a response to the host device 100 if the information contained in the scanning function field 410 is identical to their own scanning function.

The general-purpose image reading apparatus driver unit 114 controls the display unit 140 to display a list of image reading apparatuses. If an image reading apparatus to be used is selected from the list of image reading apparatuses on the display unit 140, the general-purpose image reading apparatus driver unit 114 controls the display unit 140 to display a driver UI corresponding to the selected image reading apparatus. In addition, the general-purpose image reading apparatus driver unit 114 controls the selected image reading apparatus to perform the scanning function using the displayed driver UI.

The input unit 120 receives an operating signal input through an input device, such as a keyboard or a mouse, of the host device 100 by the user.

Operating signals of the user for diverse UIs and a menu provided by the application unit 112 and the general-purpose image reading apparatus driver unit 114 are input through the input unit 120.

The storage unit 130 stores diverse information needed for the operation of the host device 100.

In this embodiment, the storage unit 130 may store a preset setting, which is generated by the general-purpose image reading apparatus driver unit 114, including setting values for a scanning function. In each preset setting stored in the storage unit 130, an image reading apparatus may be matched with setting values for a scanning function.

Since the storage unit 130 may store a preset setting including setting values for a scanning function, the user does not need to re-input the setting values for the scanning function in order to use the same setting values for the scanning function.

The display unit 140 displays diverse information which the host device 100 provides the user. In this embodiment, the display unit 140 may display diverse UIs provided by the application unit 112 and the general-purpose image reading apparatus driver unit 114, and may display a list of image reading apparatuses and a use list.

The interface unit 150 supports interfaces between the host device 100 and the image reading apparatuses 300a to 300e. Since the host device 100 is locally connected to the image reading apparatus 300a, and is connected to the remaining image reading apparatus 300b to 300e via the network 200, interfaces for connection are substantially different. However, interfaces for both local connection and network connection are not distinguished for convenience of description.

The image reading apparatus 300 may include an interface unit 310, a scan unit 320, a storage unit 330, and a control unit 340. The plurality of image reading apparatuses 300a to 300e shown in FIG. 1 may have such a structure in common. In addition, the image reading apparatus 300 may further include an element, such as a display window, but such an element is unnecessary for description of the present embodiments, and is thus omitted here.

The interface unit 310 supports an interface between the image reading apparatus 300 and the host device 100. More specifically, the interface unit 310 receives a search signal from the host device 100, and transmits a response (referred to hereinafter as “response signal”) to the search signal to the host device 100 according to operation of the control unit 340.

The search signal received through the interface unit 310 may be one of a search signal requesting a response from all the image reading apparatuses 300a to 300e which are connected to the host device 100, and a search signal including information regarding a scanning function. According to the search signal received through the interface unit 310, it may be determined whether or not the image reading apparatus 300 responds to the search signal.

The scan unit 320 performs a scanning function of the image reading apparatus 300. If the scan unit 320 receives an operation command from the host device 100, the scan unit 320 performs a scanning function according to a setting value for the scanning function.

The storage unit 330 stores all of the information needed to operate the image reading apparatus 300, and also may store a scanning function which the image reading apparatus 300 can support. A scanning function stored in the storage unit 330 may include at least one of a resolution range, a flatbed size, a support of ADF, a support of double-sided ADF, a speed of ADF, a paper capability of ADF, and types of supportable ports, for example.

The control unit 340 controls the overall operation of the image reading apparatus 300. That is, the control unit 340 controls input and output of a signal among the interface unit 310, the scan unit 320, and the storage unit 330. If the control unit 320 receives a search signal from the host device 100 through the interface unit 310, the control unit 320 determines whether to transmit a response signal to the host device 100 according to the type of search signal.

More specifically, if the search signal is a search signal requesting a response from all the image reading apparatuses 300a to 300e, the control unit 340 transmits a response signal through the interface unit 310. The response signal may include simple device information regarding the image reading apparatus 300 transmitting the response signal.

However, if the search signal is a search signal including scanning function information, the control unit 340 compares the scanning function information with the scanning function stored in the storage unit 330, and transmits a response signal to the host device 100 through the interface unit 310 if there is coincident information. In this case, the response signal may include simple device information of the image reading apparatus 300 transmitting the response signal.

If there is no coincident information between the scanning function information contained in the search signal and the scanning function stored in the storage unit 330, the control unit 340 does not transmit a response signal to the host device 100.

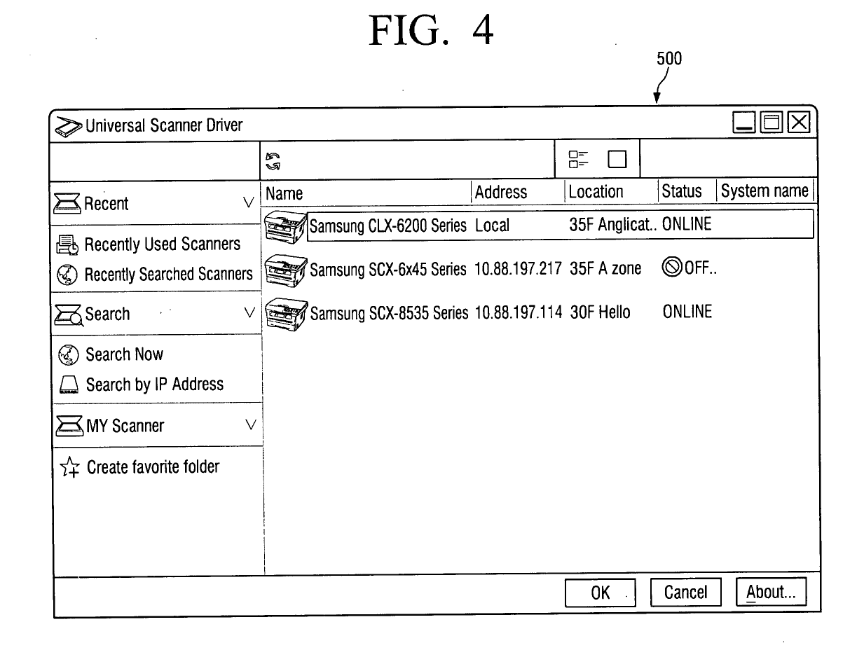

FIG. 4 illustrates an example of a user interface to display a list of image reading apparatuses according to an example embodiment.

In FIG. 4, a UI 500 showing a list of image reading apparatuses is illustrated as a result of searching for image reading apparatuses which are connected to the host device 100 using the general-purpose image reading apparatus driver unit 114.

Referring to the UI 500 illustrated in FIG. 4, three image reading apparatuses are found, and simple device information, such as device name, address, location, and status is displayed. The user may select an image reading apparatus to be used from the list of image reading apparatuses in the UI 500.

The three image reading apparatuses in the UI 500 may illustrate that there are three image reading apparatuses 300 which are connected to the host device 100, or illustrate that there are more than three image reading apparatuses 300 which are connected to the host device 100, but among them only three image reading apparatuses 300 support a desired scanning function.

FIGS. 5A to 5C illustrate examples of a UI to allow a user to input a scanning function according to an example embodiment.

An example of a UI 600 for the general-purpose image reading apparatus driver unit 114 receiving input of a scanning function to be used by the user is illustrated in FIG. 5A. Referring to FIG. 5A, the UI 600 may include a setting value input area 620 to input at least one setting value for a scanning function, and a preset generation area 610 to designate a preset name in order to generate a preset setting including a setting value input in the setting value input area 620.

The user may designate a desired preset name in the preset generation area 610, and generate a preset setting having a desired setting value for a scanning function by pressing a “STORE” button. If the user presses a “DELETE” button, a previously generated preset setting may be deleted.

A state of showing previously generated preset settings is illustrated in a UI 600′ to allow a user to input a scanning function of FIG. 5B. The user may generate a new preset setting or delete a previously generated preset setting. In addition, since the previously generated preset settings are stored, the user may select one of the previously generated preset settings without newly inputting a setting value for a scanning function to the UI 600′.

FIG. 5C illustrates a UI 600″ to receive a user input of a scanning function when the user selects one of the previously generated preset settings. The user may change a setting value for a scanning function set for the selected preset setting to another setting value. Comparing the UI 600′ of FIG. 5B with the UI 600″ of FIG. 5C, some setting values are changed.

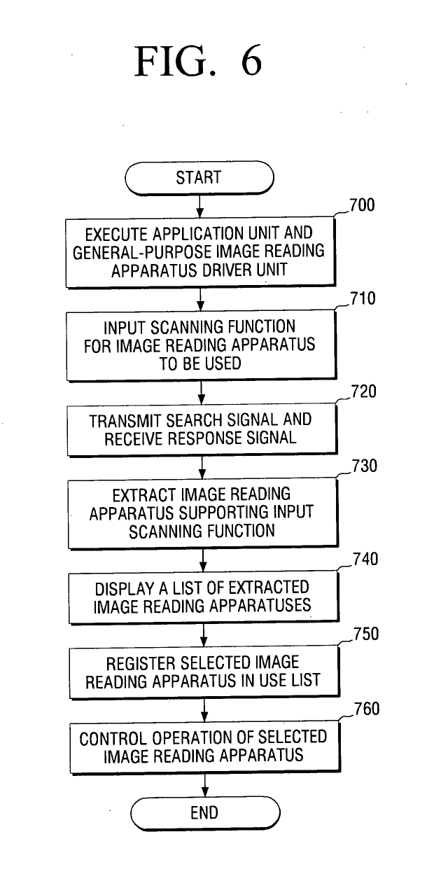

FIG. 6 is a flow chart illustrating a method of controlling the image reading apparatus using the host apparatus according to an example embodiment.

Referring to FIGS. 1 to 6, an example embodiment in which, when the general-purpose image reading apparatus driver unit 114 searches for an image reading apparatus 300, all the image reading apparatuses 300a to 300e which are connected to the host device 100 respond to a search signal is described below.

The user executes the application unit 112, and selects the general-purpose image reading apparatus driver unit 114 in a menu provided by the application unit 112, so the general-purpose image reading apparatus driver unit 114 can be executed in operation 700.

If the general-purpose image reading apparatus driver unit 114 is executed, the general-purpose image reading apparatus driver unit 114 provides a UI 600 to receive as input a scanning function as illustrated in FIG. 5A. The user inputs a setting value for a desired scanning function to the UI 600 displayed on the display unit 140 in operation 710.

The general-purpose image reading apparatus driver unit 114 generates a search signal requesting a response from all the image reading apparatuses 300a to 300e which are connected to the host device 100, and transmits the search signal through the interface unit 150 at operation 720. Subsequently, all the image reading apparatuses 300a to 300e which are connected to the host device 100 receive the search signal, and transmit a response signal to the host device 100. The interface unit 150 receives the response signal from the image reading apparatuses 300a to 300e in operation 720.

The general-purpose image reading apparatus driver unit 114 receives the response signal from the image reading apparatuses 300a to 300e, and extracts image reading apparatuses capable of supporting the scanning function input through the UI 600 based on the scanning function of each image reading apparatus contained in each response signal in operation 730.

The general-purpose image reading apparatus driver unit 114 displays a list of the extracted image reading apparatuses on the display unit 140 in operation 740. Accordingly, the user selects an image reading apparatus to be used from the list of the image reading apparatuses on the display unit 140.

If a signal to select an image reading apparatus to be used is input through the input unit 120, the general-purpose image reading apparatus driver unit 114 registers the selected image reading apparatus in a use list in operation 750, and controls a scanning operation of the selected image reading apparatus. That is, the general-purpose image reading apparatus driver unit 114 transmits an operating command to the selected image reading apparatus so that the selected image reading apparatus can perform scanning based on the setting value set for the scanning function in operation 760.

Following this process, the general-purpose image reading apparatus driver unit 114 searches for all the image reading apparatuses which are connected to the host device 100 as in related-art general-purpose driver units, but extracts only image reading apparatuses supporting a scanning function desired by the user from among the searched image reading apparatuses, and provides a list of extracted image reading apparatuses. Accordingly, the user can select a desired image reading apparatus from among the image reading apparatuses supporting the scanning function desired by the user.

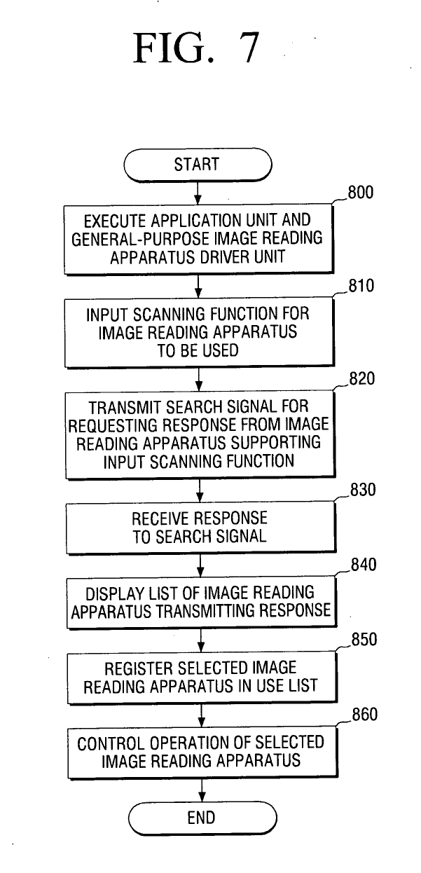

FIG. 7 is a flow chart illustrating a method of controlling an image reading apparatus using a host apparatus according to another embodiment.

Referring to FIGS. 1 to 5 and 7, an example embodiment in which, when the general-purpose image reading apparatus driver unit 114 searches for an image reading apparatus 300, only image reading apparatuses supporting a desired scanning function from among the image reading apparatuses 300a to 300e which are connected to the host device 100 respond to a search signal is described below.

The application unit 112 and the general-purpose image reading apparatus driver unit 114 are executed in operation 800. The general-purpose image reading apparatus driver unit 114 receives input of a scanning function for an image reading apparatus to be used through a UI 600 to receive an input of a scanning function in operation 810.

The general-purpose image reading apparatus driver unit 114 generates a search signal requesting a response only from image reading apparatuses supporting the input scanning function, and transmits the search signal to the image reading apparatuses 300a to 300e through the interface unit 150 in operation 820. The search signal may have a structure as shown in FIG. 3.

The image reading apparatuses 300a to 300e each receive the search signal from the host device 100, compare their own scanning function with information regarding the scanning function contained in the search signal, and transmit a response signal to the host device 100 according to the result of comparison. The host device 100 receives the response signal through the interface unit 150 in operation 830.

The general-purpose image reading apparatus driver unit 114 generates a list of only image reading apparatuses transmitting the response signal, and displays the list on the display unit 140 in operation 840.

If the list is displayed on the display unit 140, the user selects an image reading apparatus to be used, and the general-purpose image reading apparatus driver unit 114 registers the selected image reading apparatus in a use list in operation 850 and controls a scanning operation of the selected image reading apparatus in operation 860.

Following this process, the general-purpose image reading apparatus driver unit 114 does not receive a response signal from all the image reading apparatuses 300a to 300e which are connected to the host device 100. That is, since the general-purpose image reading apparatus driver unit 114 receives a response signal only from image reading apparatuses supporting a scanning function input by the user, the user may select a desired image reading apparatus from among the image reading apparatuses supporting the scanning function to be used with greater ease.

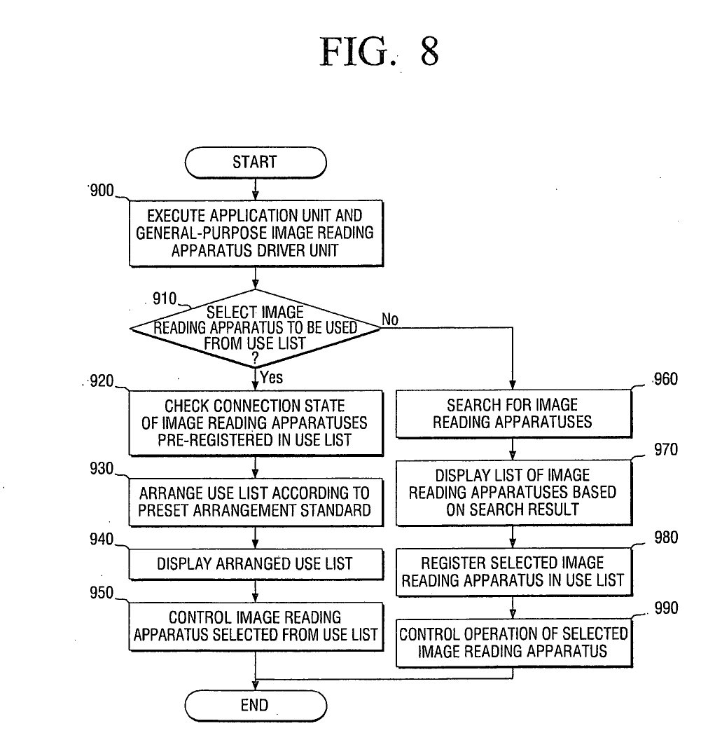

FIG. 8 is a flow chart illustrating a method of controlling an image reading apparatus using a host apparatus according to yet another embodiment.

Referring to FIGS. 1 to 5 and 8, when there are image reading apparatuses which are searched and registered in a use list in the process as shown in FIG. 6 or FIG. 7, a method of controlling an image reading apparatus using the host device 100 is discussed below.

The application unit 112 and the general-purpose image reading apparatus driver unit 114 are executed in operation 900. If the user wishes to select an image reading apparatus to be used from a pre-registered use list through the general-purpose image reading apparatus driver unit 114 in operation 910-Y, the general-purpose image reading apparatus driver unit 114 checks a connection state of image reading apparatuses which are pre-registered in the use list in operation 920.

Subsequently, the general-purpose image reading apparatus driver unit 114 arranges the use list according to a preset arrangement standard in operation 930, and displays the arranged use list on the display unit 140 in operation 940. The preset arrangement standard may be one of an on/off state of an image reading apparatus, a frequency in use, and a scanning function.

If the use list is displayed on the display unit 140, the user may select an image reading apparatus to be used from the use list. If the user selects an image reading apparatus to be used, the general-purpose image reading apparatus driver unit 114 controls the selected image reading apparatus to perform a scanning function in operation 950.

If the user does not wish to select an image reading apparatus to be used from the use list in operation 910-N, the general-purpose image reading apparatus driver unit 114 searches for image reading apparatuses in operation 960. The operation of searching for image reading apparatuses corresponds to one of operation 720 to 730 shown in FIG. 6 and operation 820 to 830 shown in FIG. 7.

The general-purpose image reading apparatus driver unit 114 displays a list of image reading apparatuses based on the search result of operation 960 in operation 970, registers an image reading apparatus selected by the user in the use list in operation 980, and controls the selected image reading apparatus to perform a scanning function in operation 990.

Following this process, the user may use an image reading apparatus which has been previously searched for by selecting the image reading apparatus from the pre-registered use list without performing a searching operation. In this case, since the use list is displayed according to the preset arrangement standard, the user may select a desired image reading apparatus with greater ease.

Although a few embodiments have been shown and described, it would be appreciated by those skilled in the art that changes may be made in this embodiment without departing from the principles and spirit of the invention, the scope of which is defined in the claims and their equivalents.

What is claimed is:

1. A method of controlling an image reading apparatus using a host device connected to at least one image reading apparatus, the method comprising:
receiving input of at least one scanning function for an image reading apparatus to be used;
searching for at least one image reading apparatus connected to the host device;
extracting at least one image reading apparatus supporting the at least one scanning function based on the search result;
displaying a list of the extracted at least one image reading apparatus; and
displaying a driver user interface (UI) corresponding to the selected image reading apparatus when an image reading apparatus to be used is selected from the list.

2. The method according to claim 1, further comprising performing a scanning operation of the selected image reading apparatus based on an input received at the driver UI.

3. The method according to claim 14, further comprising executing the general-purpose image reading apparatus driver unit,
wherein the general-purpose image reading apparatus driver unit provides a UI to receive the at least one scanning function as input.

4. The method according to claim 1, wherein the at least one scanning function is input using a preset setting indicating a pre-stored scanning function.

5. The method according to claim 4, wherein receiving the input comprises:
displaying at least one pre-stored preset setting; and
receiving the input of the at least one scanning function by selecting at least one of the displayed preset settings.

6. The method according to claim 1, further comprising registering the selected image reading apparatus in a use list.

7. A method of controlling an image reading apparatus using a host device having a general-purpose image reading apparatus driver unit capable of controlling a plurality of image reading apparatuses, the method comprising:
executing the general-purpose image reading apparatus driver unit;
receiving input of at least one scanning function for one of the image reading apparatuses to be used;
searching for at least one image reading apparatus which is connected to the host device based on the input scanning function;
receiving a response from at least one image reading apparatus supporting the input scanning function;
displaying a list of the at least one image reading apparatus which transmits the response; and
displaying a driver user interface (UI) corresponding to a selected image reading apparatus when an image reading apparatus to be used is selected from the list.

8. The method according to claim 7, further comprising performing a scanning operation of the selected image reading apparatus based on the driver UI.

9. The method according to claim 7, wherein the response from the at least one image reading apparatus contains a scanning function supported by the at least one image reading apparatus.

10. A host device connected to at least one image reading apparatus, the host device comprising:
an input unit to receive input of at least one scanning function for an image reading apparatus to be used;
a general-purpose image reading apparatus driver unit to search for the at least one image reading apparatus connected to the host device, and to extract at least one image reading apparatus supporting the at least one scanning function based on the search result; and
a display unit to display a list of the extracted at least one image reading apparatus,
wherein the general-purpose image reading apparatus driver unit displays a driver user interface (UI) corresponding to a selected image reading apparatus on the display unit when an image reading apparatus to be used is selected from the list.

11. A host device connected to at least one image reading apparatus, the host device comprising:
an input unit to receive input of at least one scanning function for an image reading apparatus to be used;
a general-purpose image reading apparatus driver unit to search for at least one image reading apparatus connected to the host device based on the input scanning function;
an interface unit to receive a response from at least one image reading apparatus supporting the input scanning function; and
a display unit to display a list of the at least one image reading apparatus that transmits the response,
wherein the general-purpose image reading apparatus driver unit displays a driver user interface (UI) corresponding to a selected image reading apparatus on the display unit when an image reading apparatus to be used is selected from the list.

12. An image reading apparatus connected to a host device and operating according to control of the host device, the image reading apparatus comprising:
a storage unit storing supportable scanning information;
an interface unit to receive a search signal from the host device; and
a control unit compares information regarding the scanning function with the scanning information stored in the storage unit when the search signal contains information regarding a scanning function, and transmits a response signal to the host device through the interface unit when at least one information regarding the scanning function is identical with the scanning information stored in the storage unit as a result of the comparison.

13. The image reading apparatus according to claim 12, wherein the control unit does not transmit the response signal to the host device when there is no identical information as a result of the comparison.

14. The method according to claim 1, wherein the host device includes a general-purpose image reading apparatus driver unit capable of controlling the at least one image reading apparatus.

15. A method of controlling an image reading apparatus using a host device connected to at least one image reading apparatus, the method comprising:
receiving input of at least one desired scanning function for at least one of the image reading apparatuses to be controlled;
transmitting a search signal to search for at least one image reading apparatus from the at least one image reading apparatus connected to the host device;
receiving a response signal from at least one image reading apparatus connected to the host device in response to the search signal; and
extracting at least one image reading apparatus capable of supporting the desired scanning function based on a result of the received response signals and displaying a list of the extracted at least one image reading apparatus.

16. The method according to claim 15, wherein the search signal is a signal requesting a response signal from all of the image reading apparatuses connected to the host device, and the host device determines image reading apparatuses capable of supporting the desired scanning function based on the response signals received from all of the image reading apparatuses connected to the host device.

17. The method according to claim 15, wherein the search signal is a signal requesting a response signal only from image reading apparatuses capable of supporting the desired scanning function, and the host device determines image reading apparatuses capable of supporting the desired scanning function based on the response signals received from only the image reading apparatuses connected to the host device.

18. The method according to claim 15, wherein one of the image reading apparatuses is selected from the list and controlled to perform the desired scanning function.

19. The method according to claim 15, wherein a determination is made, prior to searching for the image reading apparatuses, as to whether an image reading apparatus to be used is to be selected from a pre-registered use list, and an image reading apparatus from the pre-registered use list is selected from the use list and controlled to perform the desired scanning function when it is determined that the image reading apparatus to be used is to be selected from the pre-registered use list.
